(19) United States
(12) Patent Application Publication
(10) Pub. No.: US 2020/0327633 A1
(43) Pub. Date: Oct. 15, 2020

(54) DELIVERY VEHICLE MANAGEMENT SYSTEM

(71) Applicant: TOYOTA JIDOSHA KABUSHIKI KAISHA, Toyota-shi (JP)

(72) Inventors: Junichi Goto, Toyota-shi (JP); Masao Hitomi, Toyota-shi (JP); Yu Nishikata, Tokyo (JP); Kousuke Matsuyama, Tokyo (JP); Maiko Eguchi, Tokyo (JP); Seiji Kuroki, Tokyo (JP); Hiroaki Kawahara, Tokyo (JP); Yohei Tanigawa, Toyota-shi (JP); Yoshihisa Sugano, Tokyo (JP); Hiroaki Takahashi, Tokyo (JP); Tomoyuki Tanaka, Tokyo (JP); Kosuke Katou, Tokyo (JP); Tokihiro Motoyama, Tokyo (JP)

(73) Assignee: TOYOTA JIDOSHA KABUSHIKI KAISHA, Toyota-shi (JP)

(21) Appl. No.: 16/846,650

(22) Filed: Apr. 13, 2020

(30) Foreign Application Priority Data
Apr. 15, 2019 (JP) 2019-076987

(51) Int. Cl. G06Q 50/28; G06Q 10/08

(52) U.S. Cl. CPC G06Q 50/28; G06Q 10/087; G06Q 10/0833; G06Q 10/08355

(57) ABSTRACT

A delivery vehicle management system stores a delivery plan information regarding a traveling scheduled path of each of a plurality of delivery vehicles, acquires a position information indicating a current position of each delivery vehicle, calculates an expected arrival time for each delivery vehicle to reach a cross dock based on the delivery plan information and the position information of each delivery vehicle, specifies the delivery vehicle in which a standby time occurs when each delivery vehicle is permitted to use the cross dock in an order in which the expected arrival time is earlier, and a length of the standby time of each delivery vehicle, and notifies a driver of the delivery vehicle specified by the specifying unit of a time point delayed from the expected arrival time by the length of the standby time as a time point at which use of the cross dock can be started.

### TECHNICAL FIELD

The present disclosure relates to a delivery vehicle management system.

### CROSS-REFERENCE TO RELATED APPLICATION

This application claims the benefit of priority from Japanese Patent Application No. 2019-076987, filed Apr. 15, 2019, the entire contents of which are incorporated herein by reference.

### BACKGROUND

In the related art, a cross dock (cargo handling facility) such as a delivery center having a base function for transshipping a load of a delivery vehicle such as a truck is known. The cross dock is used by a plurality of delivery vehicles. Thus, if a timing at which a delivery vehicle enters the cross dock is left to the judgment or a driver of the delivery vehicle, there is concern that delivery vehicles are delayed in the cross dock or around the cross dock. Japanese Unexamined Patent Publication No. 2007-34566 discloses a system that notifies each driver of a delivery vehicle of a time at which the delivery vehicle is permitted to enter a cross dock in order to solve the problem.

### SUMMARY

In the system disclosed in Japanese Unexamined Patent Publication No. 2007-34566, entry permission time (entry time period) for each delivery vehicle is determined on the basis of a required traveling time that is obtained according to a delivery destination (that is, a predefined operation schedule) allocated to each delivery vehicle. However, the required traveling time may be changed depending on an actual delivery status (for example, a traffic status of a road used by a delivery vehicle). Thus, if an entry permission time is determined in a fixed manner on the basis of a predefined operation schedule as in the system, there is concern that a discrepancy may occur between an order of entry permission times allocated to respective delivery vehicles and an order in which the respective delivery vehicles can actually reach the cross dock. Due to the discrepancy, there is concern that a time period may occur in which the cross dock is not used by any delivery vehicle or an unnecessarily much standby time may be imposed on a specific delivery vehicle.

Therefore, an object of the present disclosure is to provide a delivery vehicle management system capable of achieving efficient use of a cargo handling facility and also reducing a standby time of each delivery vehicle.

According to an aspect of the present disclosure, there is provided a delivery vehicle management system including a delivery plan information storage unit configured to store a delivery plan information including information regarding a traveling scheduled path of each of a plurality of delivery vehicles heading toward a cargo handling facility via one or more locations where loading or unloading is performed; a position information acquisition unit configured to acquire a position information indicating a current position of each delivery vehicle; a calculation unit configured to calculate an expected arrival time for each delivery vehicle to reach the cargo handling facility on the basis of the delivery plan information of each delivery vehicle and the position information; a specifying unit configured to specify the delivery vehicle in which a standby time occurs and a length of the standby time of each delivery vehicle when each delivery vehicle is permitted to use the cargo handling facility in an order in which the expected arrival time is earlier; and a notification unit configured to notify a driver of the delivery vehicle specified by the specifying unit of a time point delayed from the expected arrival time by the length of the standby time as a time point at which use of the cargo handling facility can be started.

In the delivery vehicle management system, an expected time for each delivery vehicle to reach the cargo handling facility is obtained with high accuracy on the basis of the delivery plan information and the current position of each delivery vehicle. A driver of a delivery vehicle in which a standby time occurs when each delivery vehicle is permitted to use the cargo handling facility in an expected arrival time order is notified of a time point delayed from the expected arrival time by the standby time as a time point at which use of the cargo handling facility can be started. Consequently, the driver can delay a time point to reach the cargo handling facility to the notified time point. As a result, a standby time of the delivery vehicle can be reduced, and the driver can efficiently use an unoccupied time. The cargo handling facility is used in an order in which an expected arrival time obtained with high accuracy on the basis of the current position of each delivery vehicle is earlier, and thus it is possible to prevent the occurrence of a time period in which the cargo handling facility is not used by any delivery vehicle. As mentioned above, the delivery vehicle management system can achieve efficient use of the cargo handling facility and reduce a standby time of each delivery vehicle.

The specifying unit may acquire a load information regarding a load brought to the cargo handling facility by each delivery vehicle, determine a use time for which each delivery vehicle uses the cargo handling facility on the basis of the load information of each delivery vehicle, and specify the delivery vehicle in which the standby time occurs and the length of the standby time of each delivery vehicle by using the use time determined for each delivery vehicle. According to this configuration, it is possible to predict a use time for which each delivery vehicle uses the cargo handling facility with high accuracy on the basis of the load information of each delivery vehicle. As a result, it is possible to specify a length of a standby time of each delivery vehicle with high accuracy.

According to the present disclosure, it is possible to provide the delivery vehicle management system that can achieve efficient use of a cargo handling facility and reduce a standby time of each delivery vehicle.

### BRIEF DESCRIPTION OF THE DRAWINGS

FIG. 1 is a diagram illustrating a configuration of a delivery vehicle management system according to an embodiment.

FIG. 2 is a diagram schematically illustrating an example of delivery plan information.

FIGS. 3A and 3B are diagrams for describing an effect achieved by the delivery vehicle management system.

FIG. 4 is a flowchart illustrating an example of the delivery vehicle management system.

### DETAILED DESCRIPTION

Hereinafter, a description will be made of an embodiment of the present disclosure with reference to the drawings. Throughout the drawings, an identical or similar portion is given an identical reference numeral, and an overlapping description will not be repeated.

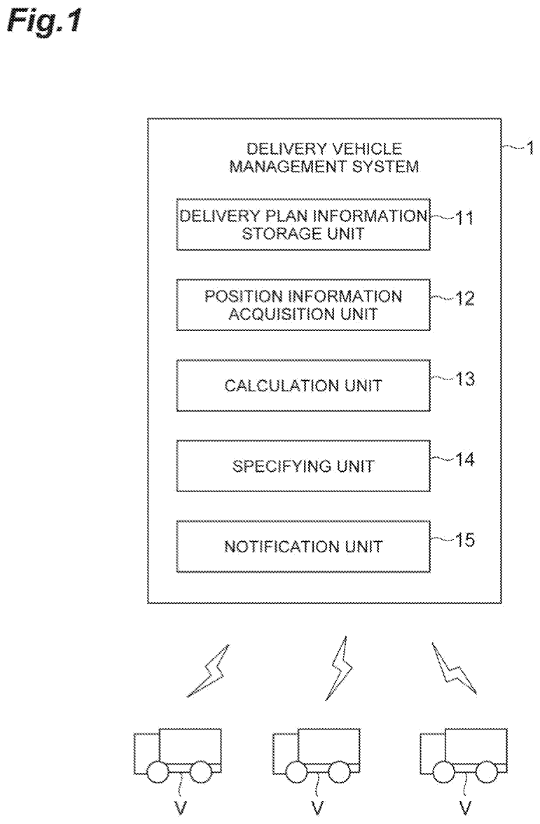

FIG. 1 is a diagram illustrating a configuration of a delivery vehicle management system 1 according to an embodiment of the present disclosure. As illustrated in. FIG. 1, the delivery vehicle management system 1 is a system managing a plurality of delivery vehicles V. The delivery vehicle management system 1 is, for example, a computer system provided in a cargo handling facility having a base function for transshipping loads of the delivery vehicles V. The cargo handling facility is, for example, a cross dock such as a delivery center serving as a base of trunk transport. In the present embodiment, the delivery vehicle management system 1 is a computer system provided in the cross dock, and the plurality of delivery vehicles V deliver loads using the cross dock as a base. For example, each delivery vehicle V has a function of delivering loads carried in the cross dock to respective delivery destinations. Each delivery vehicle V has a function of collecting loads, which are picked up in various places, in the cross dock and transshipping the loads to another delivery vehicle (for example, a large truck performing trunk transport).

The cross dock is provided with spaces for parking the delivery vehicle V and performing load handling work for the delivery vehicle V. However, there is a limitation in spaces provided in the cross dock. Thus, when many delivery vehicles V simultaneously visit the cross dock, the spaces of the cross dock are insufficient, and thus there is concern that traffic congestion may occur in the cross dock or around the cross dock due to the delivery vehicles V. Therefore, the delivery vehicle management system 1 recognizes delivery status of each of the plurality of delivery vehicles V performing delivery of load using the cross dock as a base, and notifies a driver of each delivery vehicle V of an appropriate visit time (a time point at which use of the cross dock can be started) for the cross dock.

The delivery vehicle management system 1 is configured with a computer including, for example, a processor such as a central processing unit (CPU) and a memory such as a read only memory (ROM) or a random access memory (RAM). The delivery vehicle management system 1 includes a delivery plan information storage unit 11, a position information acquisition unit 12, a calculation unit 13, a specifying unit 14, and a notification unit 15.

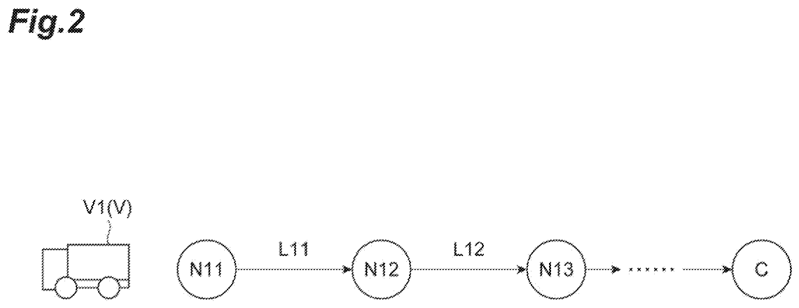

The delivery plan information storage unit 11 stores delivery plan information for each of the plurality of delivery vehicles V. The delivery plan information includes information regarding a traveling scheduled path of the delivery vehicle V heading toward the cross dock via one or more locations where loading or unloading is performed. FIG. 2 is a diagram schematically illustrating an example of the delivery plan information. In the example illustrated in FIG. 2, the delivery plan information for a certain delivery vehicle V1 includes information regarding a path in which the delivery vehicle V1 passes through a location N11, a link L11, a location N12, a link L12, and a location N13, and finally reaches a cross dock C as a traveling scheduled path of the delivery vehicle V1. The respective locations N11 to N13 correspond to specific locations such as stores for delivering or receiving loads, intersections, and the like. The respective links L11 and L12 correspond to roads and the like used by the delivery vehicle V1. Each of the locations N11 to N13 is associated with information (for example, a set of latitude and longitude) regarding a position of the location. The delivery plan information storage unit 11 stores the delivery plan information for each delivery vehicle V. The delivery plan information for each delivery vehicle V is defined on the basis of a vehicle allocation plan made by, for example, an operator of a delivery company, and is stored in advance in the delivery plan information storage unit 11 by the operator.

The position information acquisition unit 12 acquires position information indicating the current position of each delivery vehicle V For example, position information of the delivery vehicle V mounted with an on-vehicle computer may be acquired as follows. When the on-vehicle computer has a positioning function such as a GPS and a communication function of performing communication with the delivery vehicle management system 1, the position information acquisition unit 12 may acquire position information of the delivery vehicle V through communication with the on-vehicle computer of the delivery vehicle V. On the other hand, position information of the delivery vehicle V not mounted with the on-vehicle computer having the positioning function and the communication function may he acquired as follows. For example, a driver of the delivery vehicle V carries a portable terminal having the positioning function and the communication function. In this case, the position information acquisition unit 12 may acquire position it of the portable terminal as position information of the delivery vehicle V through communication with the portable terminal carried by the driver of the delivery vehicle V. In the following description, acquiring position information of the on-vehicle computer or the portable terminal through communication with the on-vehicle computer or the portable terminal will be simply referred to as “acquiring position information of the delivery vehicle V”.

The position information acquisition unit 12 periodically acquires, for example, position information of each delivery vehicle V. It is possible to recognize a delivery status (a progress status of delivery work along a traveling scheduled path) of each delivery vehicle V in real time on the basis of the periodically acquired position information of the delivery vehicle V.

The calculation unit 13 calculates an expected time for each delivery vehicle V to arrive at the cross dock C on the basis of the delivery plan information of the delivery vehicle V stored in the delivery plan information storage unit 11 and the position information acquired by the position information acquisition unit 12. The calculation unit 13 can recognize a remaining delivery path to the cross dock C from the current position of a certain delivery vehicle V on the basis of a traveling scheduled path included in delivery plan information of the delivery vehicle V and position information of the delivery vehicle V. The calculation unit 13 may also recognize the number of locations (drop-in locations) at which the delivery vehicle V drops in to deliver or pick up loads in the remaining delivery path. For example, the calculation unit 13 predicts the time required to travel on the remaining delivery path, and also calculates a work time obtained by multiplying the number of drop-in locations of the delivery vehicle V by a predefined average drop-in time per location. The calculation unit 13 may calculate an expected time for the delivery vehicle V to arrive at the cross dock C by adding the required time and the work time to the current time. The above calculation method is an example, and the calculation unit 13 may calculate an expected arrival time according to methods other than the above method. For example, an expected work time in each drop-in location may be stored in the delivery plan information. Such an expected work time in each drop-in location may be calculated in advance on the basis of, for example, an amount of loads scheduled to be loaded or unloaded in the drop-in location. In this case, the calculation unit 13 may obtain a sum of expected work times in respective drop-in locations as the work time.

The specifying unit 14 specifies the delivery vehicle V in which a standby time occurs when each delivery vehicle V is permitted to use the cross dock C in an order in which an expected arrival time is earlier, and a length of the standby time of each delivery vehicle V. Here, the standby time occurs in the delivery vehicle V visiting the cross dock C when all spaces in the cross dock C are full.

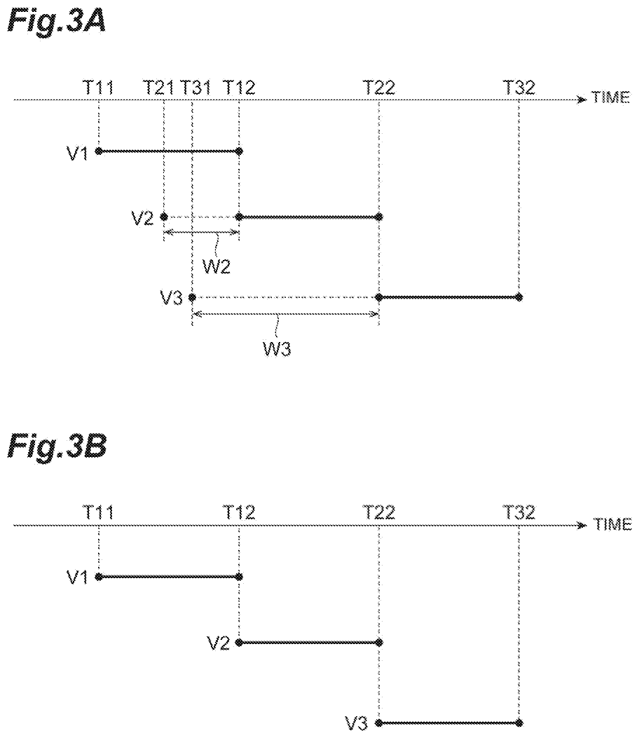

Hereinafter, with reference to FIG. 3A, the standby time will be described by using specific examples. Herein, for simplification of description, the number of spaces in the cross dock C (that is, the number of delivery vehicles V that can simultaneously use the cross dock C) is set to “one”. FIG. 3A illustrates standby times W2 and W3 occurring when it is assumed that respective expected arrival times of three delivery vehicles V1, V2, and V3 are time points T11, T21, and T31, and the respective delivery vehicles reach the cross dock C at the expected arrival times. In the example illustrated in FIG. 3A the delivery vehicle V1 reaches the cross dock C art time point T11, and completes the use of the cross dock C at time point T12. The delivery vehicle V2 reaches the cross dock C at time point T21 that is later than time point T11 and is earlier than time point T12. The delivery vehicle V3 reaches the cross dock. C at time point T31 that is later than time point T21 and is earlier than time point T12.

The standby time W2 occurs in the delivery vehicle V2 until the delivery vehicle V1 completes the use of the cross dock C. The standby time W2 is a time period (T12-T21) until the delivery vehicle V1 completes the use of the cross dock C after the delivery vehicle V2 reaches the cross dock C. The delivery vehicle V2 starts to use the cross dock C from the time point T12 after the standby time W2 elapses, and completes the use of the cross dock C at time point T22.

The standby time W3 occurs in the delivery vehicle V3 until the delivery vehicle V1 and the delivery vehicle V2 complete the use of the cross dock C. The standby time W3 is a time period (T22-T31) until the delivery vehicle V1 and the delivery vehicle V2 complete the use of the cross dock C after the delivery vehicle V3 reaches the cross dock C. The delivery vehicle V3 starts to use the cross dock C from the time point T22 after the standby time W3 elapses, and completes the use of the cross dock C at time point T32.

Here, the standby times W2 and W3 may be calculated on the basis of the expected arrival times of the respective delivery vehicles V1, V2, and V3. In the present embodiment, the standby times W2 and W3 may be calculated on the basis of the expected arrival times of the respective delivery vehicles V1, V2, and V3 and times (“T12-T11” and “T22-T12” in the above example) for the respective delivery vehicles V1 and V2 to use the cross dock C. Here, the specifying unit 14 may use, for example, a predefined average use time as a time for each delivery vehicle to use the cross dock C. In this case, the specifying unit 14 may specify the delivery vehicle in which a standby time occurs and the length of a standby time of each delivery vehicle on the basis of the average use time and an expected arrival time of each delivery vehicle V. When the number of delivery vehicles V that can simultaneously use the cross dock C is two or more, a condition in which a standby time occurs is different from the above example, but the delivery vehicle in which a standby time occurs and the length of a standby time of each delivery vehicle may be specified in the same manner as in a case where the number of delivery vehicles V that can simultaneously use the cross dock C is one.

The notification, unit 15 notifies a driver of the delivery vehicle V specified by the specifying unit 14 of a time point delayed by the length of the standby time from the expected arrival time as a time point at which use of the cross dock C can be started. In the example illustrated in FIG. 3A, the notification unit 15 notifies a driver of the delivery vehicle V2 of time point T12 that is delayed by the length of the standby time W2 from the expected arrival time (time point t21) as a time point at which use of the cross dock C can be started. The notification unit 15 notifies a driver of the delivery vehicle V3 of time point T22 that is delayed by the length of the standby time W3 from the expected arrival time (time point t31) as a time point at which use of the cross dock C can be started. If the delivery vehicles V2 and V3 are mounted with on-vehicle computers that can perform communication with the delivery vehicle management system 1, the notification unit 15 transmits messages to the on-vehicle computers of the respective delivery vehicles V2 and V3 and can thus perform the notification. On the other hand, if the delivery vehicles V2 and V3 are not mounted with the on-vehicle computers, the notification unit 15 transmits messages to portable terminals such as smart phones or tablets owned by drivers of the respective delivery vehicles V2 and V3 and can thus perform the notification.

As illustrated in FIG. 3B, the drivers of the respective delivery vehicles V2 and V3 are notified by the notification unit 15, and may thus delay time points to reach the cross dock C to the notified time points. As a result, standby times of the respective delivery vehicles V2 and V3 are reduced. FIG. 3B illustrates an ideal situation in which standby times of the respective delivery vehicles V2 and V3 are 0.

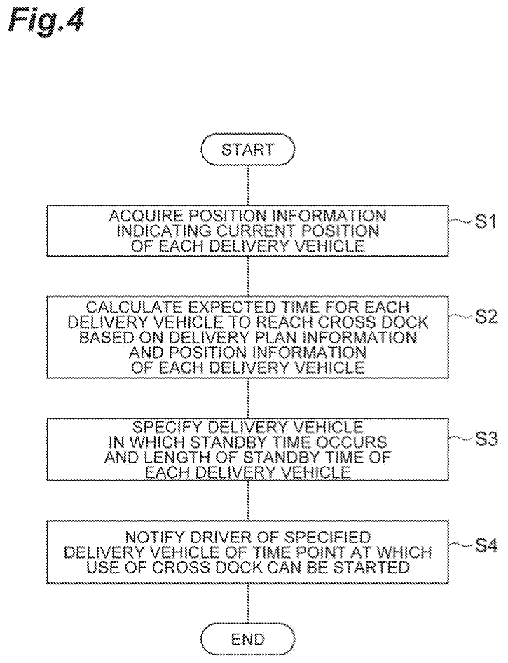

FIG. 4 is a flowchart illustrating an example of an operation of the delivery vehicle management system 1. As illustrated in FIG. 4, first, the position information acquisition unit 12 acquires position information indicating the current position of each delivery vehicle at any time point in a delivery work period of the delivery vehicle V (step S1). Next, the calculation unit 13 calculates an expected time for each delivery vehicle V to reach the cross dock C on the basis of delivery plan information of each delivery vehicle V stored in the delivery plan information storage unit 11 and the position information acquired by the position information acquisition unit 12 (step S2). Next, the specifying unit 14 specifies the delivery vehicle V in which a standby time occurs when each delivery vehicle V is permitted to use the cross dock C in an order in which an expected arrival time is earlier, and a length of the standby time of each delivery vehicle V (step S3). In the example illustrated in FIG. 3A, the specifying unit 14 specifies the delivery vehicles V2 and V3 in which standby times occur, and lengths of the standby times (the standby times W2 and W3) of the respective delivery vehicles V2 and V3. Next, the notification unit 15 notifies a driver of the delivery vehicle V specified by the specifying unit 14 of a time point delayed by the length of the standby time from the expected arrival time as a time point at which use of the cross dock C can be started (step S4).

Through the processes in steps S1 to S4, it is possible to notify a driver of each delivery vehicle V of an appropriate time to visit the cross dock C such that a standby time for using the cross dock C does not occur (in other words, such that congestion caused by the delivery vehicles V trying to use the cross dock C does not occur) on the basis of a delivery status (progress status) of each delivery vehicle V at any time point in a delivery work period. The processes in steps S1 to S4 may be periodically repeatedly performed. Consequently, a delivery status of each delivery vehicle V can be recognized in real time, and thus an expected time for each delivery vehicle V to reach the cross dock C can be appropriately updated. As a result, it is possible to appropriately update a time point at which use of the cross dock C can be started and to notify a driver of each delivery vehicle V in which a standby time occurs of the updated time point (that is, a time point with higher prediction accuracy, based on the latest states).

In the delivery vehicle management system 1, an expected time for each delivery vehicle V to reach the cross dock C is obtained with high accuracy on the basis of delivery plan information and the current position of each delivery vehicle V. Drivers of the delivery vehicles V (in the present embodiment, the delivery vehicles V2 and V3) in which standby times occur when each delivery vehicle V is permitted to use the cross dock C in an expected arrival time order are notified of time points delayed from the expected arrival times by the standby times (in the present embodiment, the standby times W2 and W3) as time points at which use of the cross dock C can be started. Consequently, the drivers can delay time points to reach the cross dock C to the notified time points. As a result, standby times of the delivery vehicles V can be reduced, and the drivers can efficiently use an unoccupied time. The cross dock C is used in an order in which expected arrival times obtained with high accuracy on the basis of the current position of each delivery vehicle V are earlier, and thus it is possible to prevent the occurrence of a time period in which the cross dock C is not used by any delivery vehicle V. Specifically, if a use order of the cross dock C is fixed on the basis of only a delivery plan of each delivery vehicle V without taking into consideration an actual delivery status, the following problems may occur. If an unexpected delay occurs in any delivery vehicle V, and thus the delivery vehicle V does not reach the cross dock C at an expected time, an idle time occurs in the cross dock C for the use time allocated to the delivery vehicle V. On the other hand, according to the present embodiment, a use order of the cross dock C is determined on the basis of a delivery status (progress status) recognized from position information of each delivery vehicle V, and thus it is possible to prevent the occurrence of the above problem. As mentioned above, the delivery vehicle management system 1 can achieve efficient use of the cross dock C and reduce a standby time of each delivery vehicle V.

As described above, the embodiment of the present disclosure has been described, but the present disclosure is not limited to the embodiment. The present disclosure may be variously modified within the scope without departing from the concept of the disclosure of the claims.

For example, the specifying unit 14 may acquire load information regarding a load brought to the cross dock C by each delivery vehicle V, and determine a use time for which each delivery vehicle V uses the cross dock C on the basis of the load information of each delivery vehicle V. The load information is, for example, information indicating the type and an amount of load, and may be information helpful in estimating the time required to handle loads in the cross dock C. The load information may be input by a driver of each delivery vehicle V using an on-vehicle computer or a portable terminal, and may be stored in delivery plan information in advance. In this case, the specifying unit 14 can predict a use time for which each delivery vehicle V uses the cross dock C with high accuracy on the basis of the load information of each delivery vehicle V. The specifying unit 14 may specify the delivery vehicle V in which a standby time occurs and a length of the standby time of each delivery vehicle V by using a use time determined for each delivery vehicle V instead of using the average use time described above.

In the embodiment, a cross dock serving as a base of trunk transport has been exemplified as a cargo handling facility, but the cargo handling facility may be facilities other than the cross dock. The cross dock may be a facility that is owned by a single delivery company (logistics company) and can be used by only the delivery vehicle V managed by the delivery company, and may be a facility that is shared by a plurality of delivery companies and can be used by the delivery vehicle V managed by each delivery company. The cross dock may be a complex facility in which a convenience store, a supermarket, a food court, a hotel (capsule hotel), a medical facility, and the like are provided together.

What is claimed is:

1. A delivery vehicle management system comprising:
a delivery plan information storage unit configured to store a delivery plan information including information regarding a traveling scheduled path of each of a plurality of delivery vehicles heading toward a cargo handling facility via one or more locations where loading or unloading is per formed;
a position information acquisition unit configured to acquire a position information indicating a current position of each delivery vehicle;
a calculation unit configured to calculate an expected arrival time for each delivery vehicle to reach the cargo handling facility on the basis of the delivery plan information and the position information of each delivery vehicle;
a specifying unit configured to specify the delivery vehicle in which a standby time occurs when each delivery vehicle is permitted to use the cargo handling Facility in an order in which the expected arrival time is earlier, and a length of the standby time of each delivery vehicle; and
a notification unit configured to notify a driver of the delivery vehicle specified by the specifying unit of a time point delayed from the expected arrival time by the length of the standby time as a time point at which use of the cargo handling facility can be started.

2. The delivery vehicle management system according to claim 1,
wherein the specifying unit is configured to acquire a load information regarding a load brought to the cargo handling facility by each delivery vehicle, determine a use time for which each delivery vehicle uses the cargo handling facility on the basis of the load information of each delivery vehicle, and specify the delivery vehicle in which the standby time occurs and the length of the standby time of each delivery vehicle by using the use time determined for each delivery vehicle.
